(19) United States
(12) Patent Application Publication
(10) Pub. No.: US 2005/0046139 A1
(43) Pub. Date: Mar. 3, 2005

(54) Weight powered engine and its usage in roller skates, roller blades and electricity generation

(76) Inventor: Shenjie Guan, Holmdel, NJ (US)

Correspondence Address: Shenjie Guan, 21 Dimisa Drive, Holmdel, NJ, 07733, US

(21) Appl. No.: 10/647,576

(22) Filed: Aug. 26, 2003

(51) Int. Cl. B62M 1/00

(52) U.S. Cl. 280/221

(57) ABSTRACT

This invention describes a compact weight powered engine and its use in building an efficient walking device. The engine utilize the energy people spent walking as the power source to drive a new type of roller skates/roller blades, either directly coupled to a shoe as a single integral unit, or they may be made so as to be attachable to a shoe; or to be use as the power source to generate electricity while walking.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTIG, COMPACT DISCK APPENDIX

Not Applicable.

### BACKGROUND OF THE INVENTION

Roller skates and roller blades have been around for decades. Over the years, they have become widely accepted as exercise devices and limited transportation tools. But as the names imply, they resemble ice skates, from looks to operations, designed for flat ground surface with little frictions. Their users have to spend energy pushing sideways, a move that far from natural walking, and less efficient on the dry land.

When walking or roller-skating, people raise their legs and body to counter gravity and move. As feet hitting back the ground, this energy is absorbed by the ground and the shoe soles, and is largely wasted. In case of roller-skating, since legs have to push sideways, the energy usage is even more inefficient. Worst of all, when moving up slopes, roller skates/blades become totally useless

To make the roller skating more natural as walking, to capture the lost energy and convert it into a useful power source, to eliminate the uphill problem without using outside power source for roller skating, this invention introduces a new type of weight powered engine, driving a new type of roller skates/roller blades, together, they can be either directly coupled to a shoe as a single integral unit, or they may be made so as to be attached to a shoe; or to be used as the power source to generate electricity while walking.

### BRIEF SUMMARY OF THE INVENTION

A compact pushdown piston engine and its applications as power source in roller skates/roller blades and electricity generation is described in this invention. The said engine uses user's body weight to push down its pistons, which rotate a crankshaft, through a gear assembly, then it can be used to either drive wheels or generate electricity. This new type of engine can be mounted under shoes. When the engine is used to drive wheels, it becomes a new type of roller skate/roller blade. Compare to the traditional roller skates/roller blades, the new ones operates more as normal walking, converts substantial gravity energy otherwise wasted to power the wheels, and eliminates the uphill problems of traditional roller skates/roller blades completely. When the engine is attached to electricity generator, it can be a power source when walking.

### BRIEF DESCRIPTION OF THE SEVERAL VIEWS OF THE INVENTION

Six figures are included in this document.

Parts in these figures are numbered and listed below:
1. Primary Flywheel. Connected to the crankshaft of the pushdown-piston assembly, it rotates in one direction
2. Secondary Gear. Driven by the primary flywheel
3. Third gear, connected to Second Gear (2) by sharing the same shaft with Second Gear (2), attached and rotate in the same speed as Second Gear (2), it is driven by Second Gear (2) and drives Wheel Driving Gear (4)
4. Wheel Driving Gear is driven by Third Gear (3) it drives wheel(s) (15) through a shaft
5. Crankshaft
6. Connect Hand that connecting the piston and the crankshaft to allow pistons' upward or downward movement to rotate crankshaft
7. Upper stopper to set crankshaft upper range
8. Lower stopper to set crankshaft lower range
9. Piston to deliver downward pressure
10. Piston Spring to help reposition piston in it top position
11. Push Step
12. Bearing
13. Gearing Assembly Housing
14. Crankshaft Housing
15. Wheel
16. Flexible Upper Piston Housing
17. Generator
18. Shoe

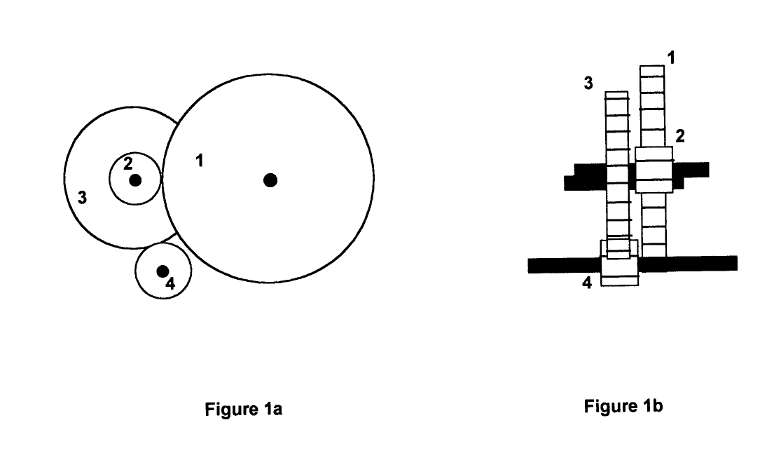

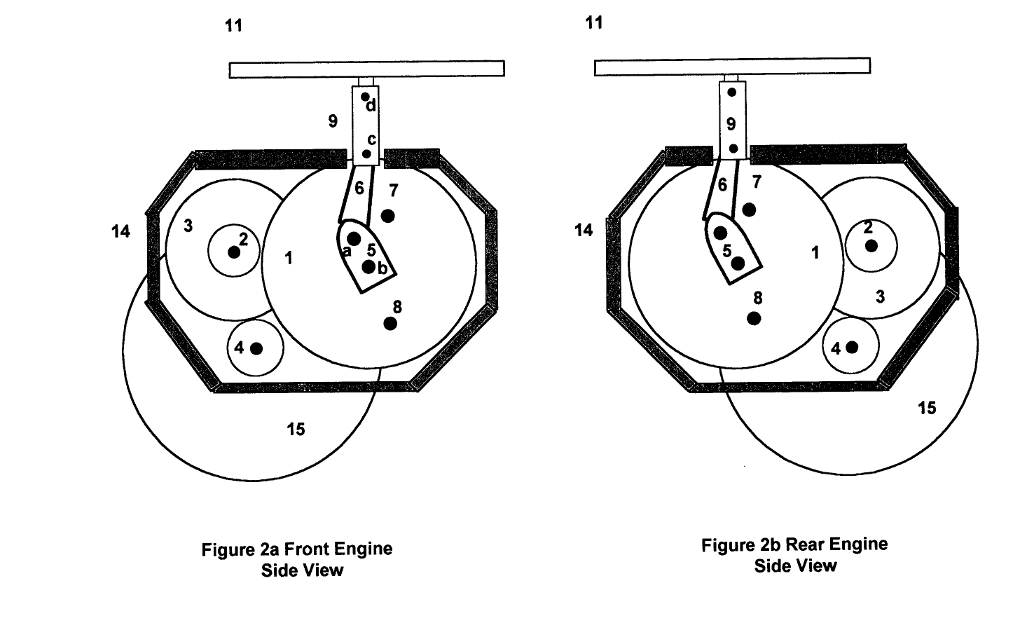

FIG. 1a is a side view of gear assembly used in pushdown-piston engine. The thick black lines in FIG. 1a are shafts.

FIG. 1b is a front view of gear assembly used in pushdown-piston engine. The thick black lines in FIG. 1b are shafts.

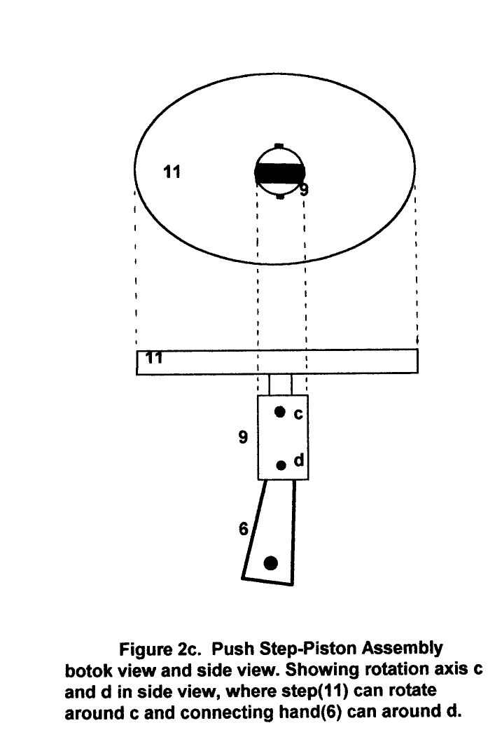

FIG. 2a is a side view of the front engine. It can be attached to front part of a shoe.

FIG. 2b is a side view of the rear engine. It can be attached to the rear part of a shoe.

FIG. 2c is a detail of step-piston-hand assembly, it shows that Push Step (11) attaches to a shoe sole through the upper plate can rotate somewhat around axis C on piston top, that flexibility provides users with comfort walking experience.

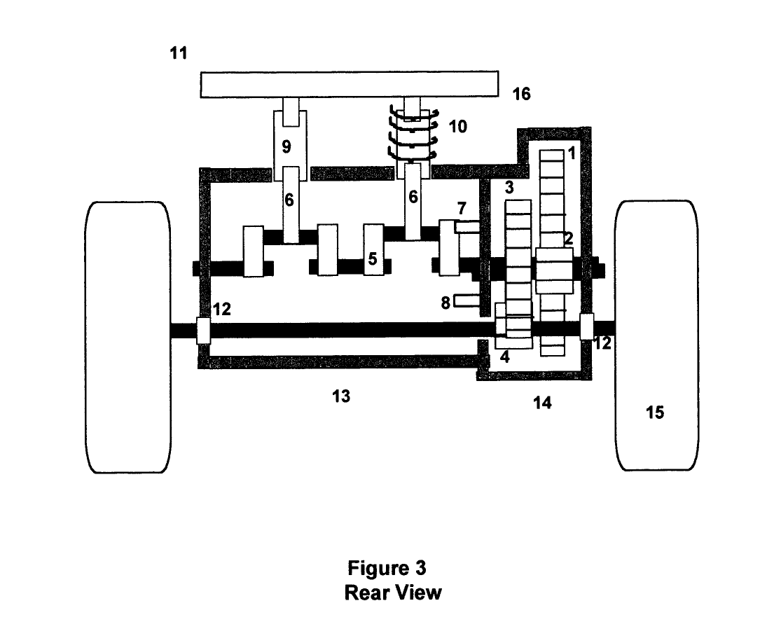

FIG. 3 gives a rear view of crankshaft assembly together with gear assembly. Two wheels (15) and wheel driving gear (4) are linked by a shaft through two bearings (12), one bearing is mounted on the crankshaft assembly housing and the other on the gear housing.

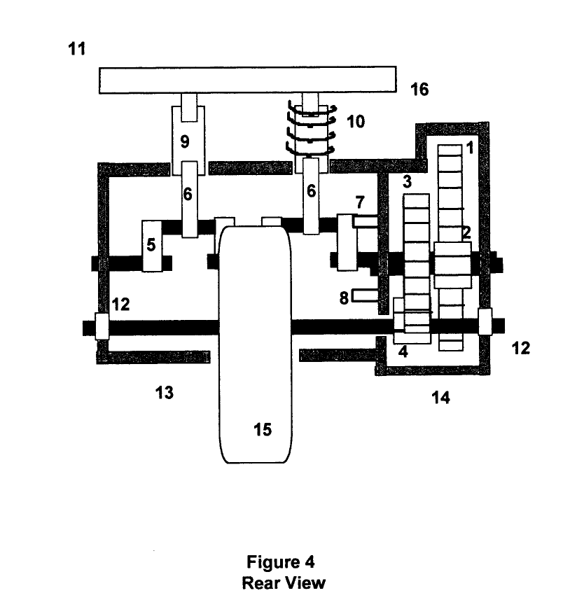

FIG. 4 is similar to FIG. 3 except only one wheel is used for a roller blade.

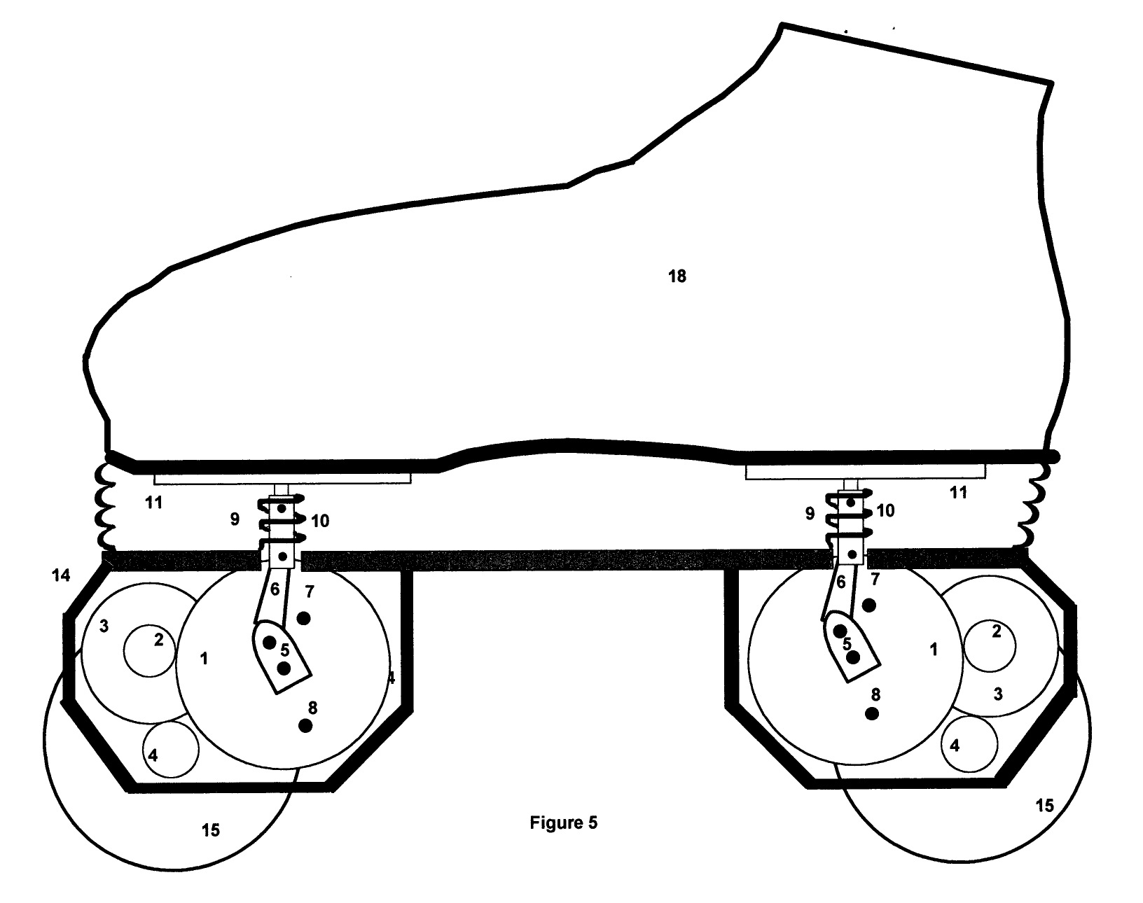

FIG. 5 is a side view of a roller skate/blade with pushdown piston engine depicted above.

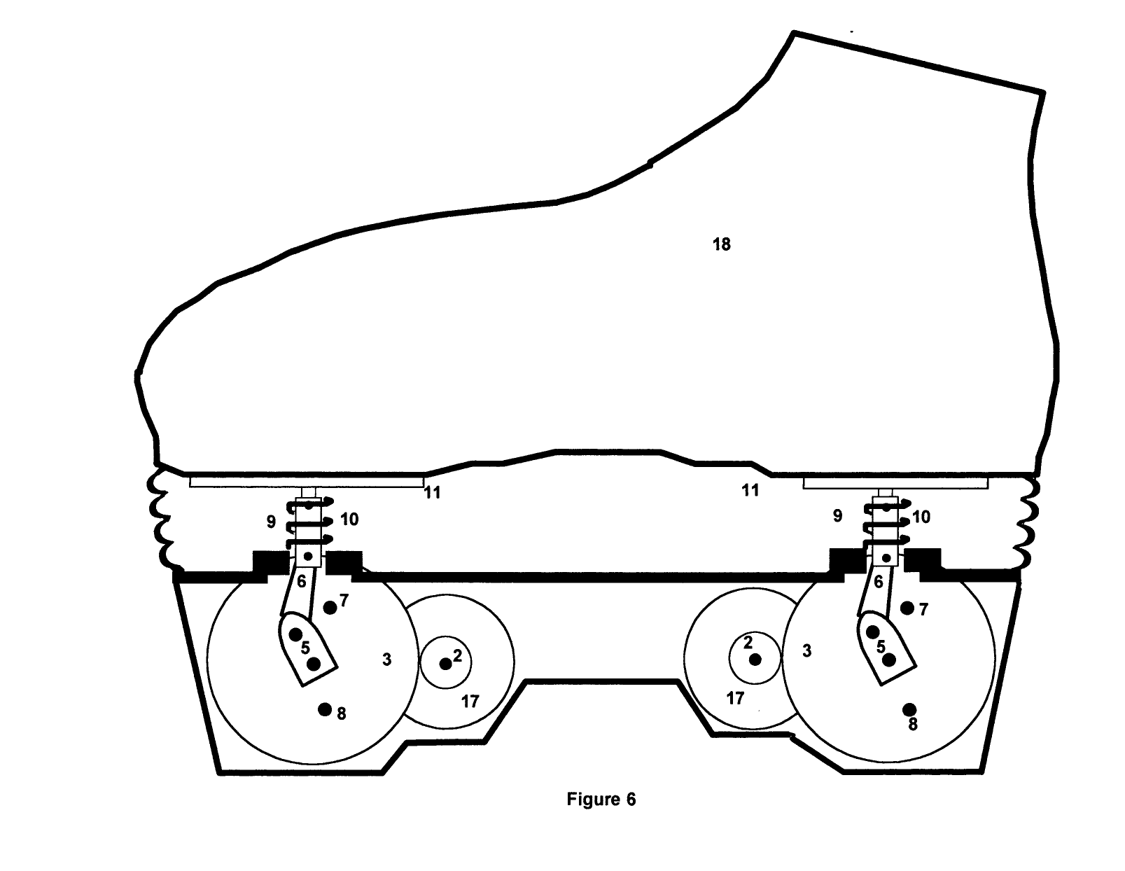

FIG. 6 is a side view of walker-generator, it allows a user to generate electricity while walking. The electricity generated by this engine can be used to light lights, drive a compact air conditioner for personal cooling or heating, etc.

### DETAILED DESCRIPTION OF THE INVENTION

The pushdown piston engine described in this invention includes push step (11), pistons and crankshaft assembly with upper and lower stoppers for crankshaft rotation limit setting. A gear assembly is used to transmit powers delivered by the crankshaft to either wheels or electricity generator. FIG. 1 shows one of the gear assemblies used. In FIGS. 1a and 1b, the flywheel (1) can rotate in only one direction. When engine piston is pushed down by push step (11), the crankshaft (5) drives the flywheel to rotate and it in turn drives the second gear (2). When engine piston traveling upward, flywheel (1) does not rotate second gear (2). This ensures that only pushdown movement of piston delivers the driving force, and when the wheels are moving forward, piston upward traveling does not have effect on the wheels.

FIGS. 2a, 2b and 2c show the side view of the engine assembly. When push step (11) is pushed downward, it pushes piston (9) downward. This in turn forces the connect hand (6) moves down and rotates crankshaft (5), which drives the flywheel (1) rotates forward. Through the gear assembly depicted in FIGS. 1a, 1b and 1c, wheel (15) is driven forward. The crankshaft continues to rotate down until it hits the lower stopper (8). Due to the use of flywheel (1), when the crankshaft (5) stopped, the wheels (15) continue to roll forward.

When the engine piston moves upward while push step (11) is lifted, the earth gravity and piston spring (10) help the crankshaft rotates back until it hits the upper stopper (7). This backward rotation puts the piston back to its starting position again readying the next downward movement, and backward rotation does not have effect on forward moving wheels thanks to the flywheel assembly depicted above. The optional piston spring (10) helps the piston back to the start position more easily.

The pushdown piston engine depicted above can have multiple uses. It can be used to drive wheels as shown in FIG. 5 as a new type of roller skate/roller blade, it can connect to a generator, as shown in FIG. 6, which depicts a shoe sole housing for electricity generation system. Note that in FIG. 6, flywheel can be replaced with an ordinary gear (3). If that is the case, the piston spring has to be strong enough to push the piston back to the starting position.

1. A pushdown piston engine system, comprising:
a. A push step (11) connecting to pistons (9) which in turn rotate crankshaft (5) through connect hands (6);
b. b. A gear transmission assembly with a flywheel (1) to ensure one direction rotation of the gears;
c. Upper and lower stoppers (7 and 8) to set crankshaft rotating range.

2. A pushdown piston engine system in claim 1, wherein said push step (11) connecting to the upper part of piston (9) can rotate with limited angles on top of the said piston

3. A pushdown piston engine system in claim 1, wherein said gear transmission assembly uses flywheel (1) to connect to crankshaft ensuring only one direction of rotation is allowed.

4. A pushdown piston engine system in claim 1, wherein said gear transmission assembly use gear (3) to connect to crankshaft as shown in FIG. 6.

5. A pushdown piston engine system in claim 1, wherein said upper and lower stoppers (7 and 8), mounted in crankshaft housing (14), are used to limit the rotation of the crankshaft in selected range.

6. A weight powered roller skate assembly comprising:
a. A pushdown piston engine system in claim 1
b. Two wheels attached to pushdown piston engine system in claim 1 through wheel driving gear (4) and bearings (12) as shown in FIG. 3

7. A weight powered roller blade assembly comprising:
a. A pushdown piston engine system in claim 1
b. A single wheel attached to pushdown piston engine system in claim 1 through wheel driving gear (4) and bearings (12) as shown in FIG. 4

8. A weight powered roller skate comprising two weight powered roller skate assembly in claim 5, the front one with wheel in front of the engine assembly and the rear one with wheel behind the engine assembly as shown in FIG. 5.

9. A weight powered roller blade comprising two weight powered roller skate assembly in claim 6, the front one with wheel in front of the engine assembly and the rear one with wheel behind the engine assembly as shown in FIG. 5
